(19) United States
(12) Patent Application Publication
(10) Pub. No.: US 2009/0008521 A1
(43) Pub. Date: Jan. 8, 2009

(54) Clamping device for a webcam

(75) Inventors: Peng-Yuan Lee, Taipei Hsien (TW); Chien-Chung Wang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: CHICONY ELECTRONICS CO. LTD, Taipei Hsien (TW)

(21) Appl. No.: 12/073,829

(22) Filed: Mar. 11, 2008

(30) Foreign Application Priority Data
Jul. 2, 2007 (TW) 96210747

(51) Int. Cl. F16L 3/08

(52) U.S. Cl. 248/226.11

(57) ABSTRACT

A clamping device for a webcam according to the present invention comprising a first arm having an extending base bearing the webcam, with a guide rail mounted at each lateral side of the base, between which the first slots are mounted for connecting purposes; a second arm having a pair of first shafts; and a connecting member having a pair of sliding tracks corresponding to the guide rails of the first arm, a pair of second shafts corresponding to the first slots with connecting purposes, and a pair of second slots with connecting purposes corresponding to the first shafts of the second arm invention comprising a first arm having an extending base bearing the webcam, with a guide rail mounted at each lateral side of the base, between which the first slots are mounted for connecting purposes; a second arm having a pair of first shafts; and a connecting member having a pair of sliding tracks corresponding to the guide rails of the first arm, a pair of second shafts corresponding to the first slots with connecting purposes, and a pair of second slots with connecting purposes corresponding to the first shafts of the second arm.

### FIELD OF THE INVENTION

The present invention relates to a clamping device for a webcam; particularly, a clamping device for a webcam capable of adjusting the clamping width.

### BACKGROUND OF THE INVENTION

With the high penetration rate of broadband internet connections, an increasing number of Internet users are communicating with distanced families and friends through audio and video peripherals. The most commonly used devices include the combination of a microphone and a sound card for voice message transmission, as well as a webcam for sending the images of the users over the Internet.

The spring-loaded design of the webcam available in the market usually follows the traditional design of a clothespin, as described in the ROC Patent No. 372081, through which the upper piece and the lower piece of the clamp are connected to each other through a pivot and a spring, so as to form a clamp-shaped mount. The way the mount works is similar to that of clothespin, in the sense that the camera is pivotably connected to the clamp shaped mount. However, this kind of design works only for monitor displays with certain width. It cannot adjust itself to fit monitor displays with various widths, nor is it secure enough to hold the webcam in place.

Therefore, it is desirable to provide a clamping device for a webcam adjustable to fit monitor displays with different widths.

### SUMMARY OF THE INVENTION

An objective of the present invention is to provide a clamping device for a webcam with adjustable clamping widths.

Another objective of the present invention is to provide a clamping device for a webcam that can adjust itself to fit the thickness of the monitor display.

Yet another objective of the present invention is to provide a clamping device for a webcam capable of two-stage adjustment according to the thickness of the monitor display.

To achieve the above-mentioned objectives, a clamping device for a webcam comprises: a first arm having an extending base bearing the webcam, with a first slot mounted at each lateral side of the base for connecting purposes; a second arm having a pair of first shafts; and a connecting member having a pair of second shafts corresponding to the first slots with connecting purposes and a pair of second slots with connecting purposes corresponding to the first shafts of the second arm. The second shafts assemble with the first arm by locking to a locking element through a spring element and through the first slots with connecting purposes. The first shafts assemble with the second arm by locking to the locking element through the spring element and through the second slots with connecting purposes. That way, the distance between the first arm and the second arm can be adjusted by pulling the first arm or the second arm to compress the spring elements inside the first slots or the second slots, so as to allow the first shafts and the second shafts to move telescopically.

The clamping device for a webcam according to the present invention further comprises an assembling portion for assembling with the webcam.

A guide rail is mounted at the opposite side of each of the first slots mounted on both sides of the base for connecting purposes, with a pair of sliding tracks corresponding to the guide rails and mounted on the connecting member, so that the connecting member can move along the first arm telescopically by sliding along the guide rails through the sliding tracks when pulling or pushing the first arm or the second arm.

Each of the first shafts and the second shafts has a securing portion for locking to the locking element.

The spring element is a spring coil; the locking element is a screw and the securing portion is a screw hole; the securing portion is a screw if the locking element is a screw nut.

A cover plate is provided at one side of the first slots on the first arm for covering the locking elements locked to the second shafts.

The clamping device for a webcam according to the present invention extends the first shafts to a distance to generate a first extension by pulling the second arm to move the first shafts and to compress the spring elements inside the second slots.

The clamping device for a webcam according to the present invention extends the second shafts to a distance to generate a second extension by pulling the second arm or the first arm again to make the connecting member move along the guide rails through the sliding tracks, so as to move the second shafts and to compress the spring element inside the first slots.

### BRIEF DESCRIPTION OF THE DRAWINGS

FIG. 1 shows an exploded view of a clamping device for a webcam according to the present invention.

FIG. 2 shows an exploded view of the clamping device for a webcam from another aspect.

FIG. 3 shows a perspective view of the assembled clamping device for a webcam.

FIG. 4 shows an action perspective view of the clamping device for a webcam.

FIG. 5 shows an action perspective view of the clamping device for a webcam mounted on a monitor display.

FIG. 6 shows an action perspective view of another embodiment of the clamping device for a webcam mounted on a monitor display.

### DETAILED DESCRIPTION OF THE EMBODIMENTS

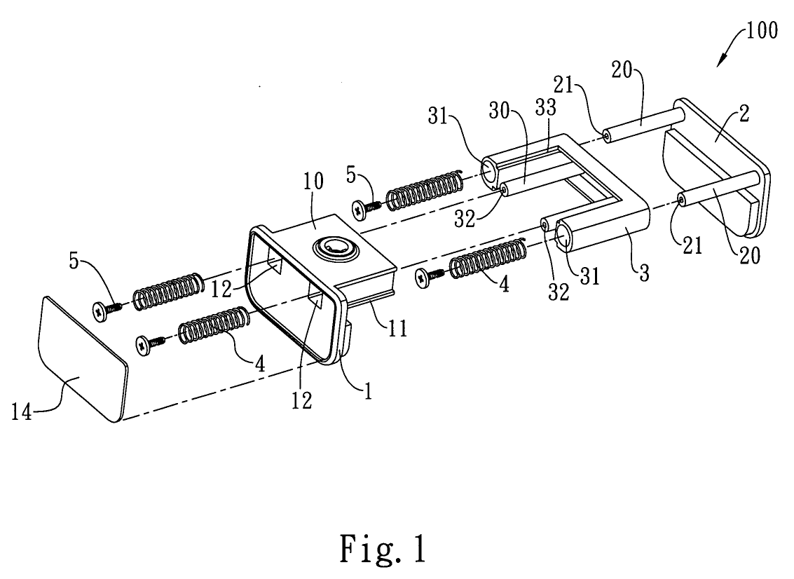

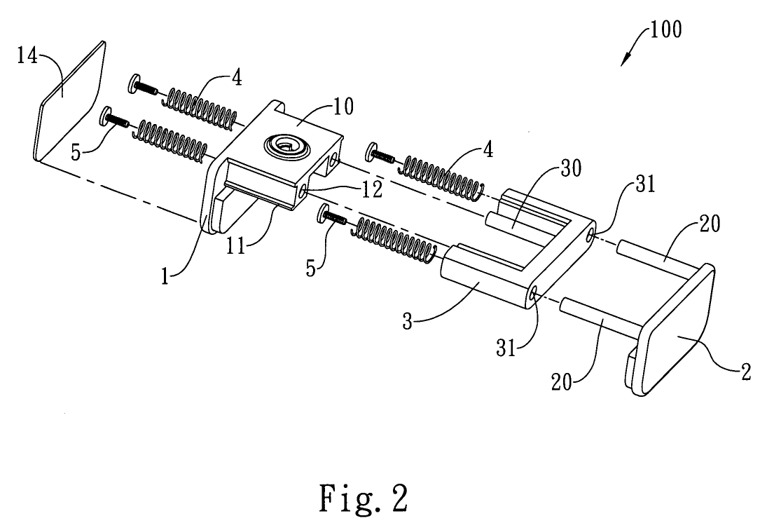

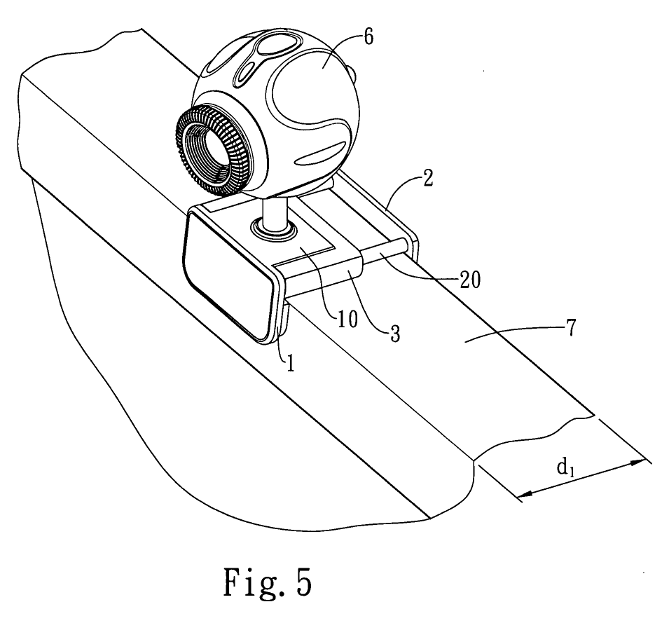

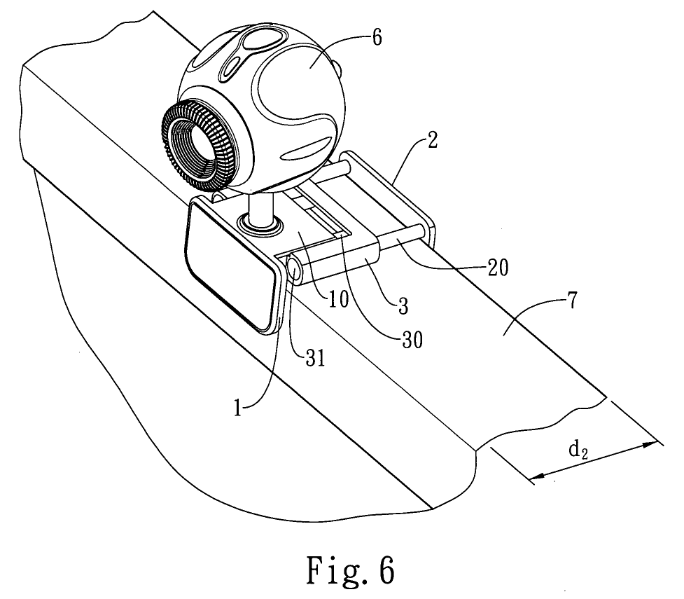

FIG. 1 and FIG. 2 respectively show the exploded views of the clamping device for a webcam from different aspects. The clamping device 100 for a webcam according to the present invention comprises: a first arm 1 having an extending base 10 bearing the webcam 6 (please refer to FIG. 5 and FIG. 6), with a guide rail 11 mounted at each lateral side of the base 10, between which the first slots 12 are mounted for connecting purposes; a second arm 2 having a pair of first shafts 20; and a connecting member 3 having a pair of sliding tracks 33 corresponding to the guide rails 11 of the first arm 1, a pair of second shafts 30 corresponding to the first slots 12 with connecting purposes, and a pair of second slots 31 with connecting purposes corresponding to the first shafts 20 of the second arm 2.

Still referring to FIG. 1 and FIG. 2, wherein the first shaft 20 is designed to assemble with the second slot 31 on the connecting member 3 and a spring element 4 is mounted between the first shaft 20 and the second slot 31. A securing portion 21 is mounted on the first shaft 20, with a locking element 5 locking to the securing portion 21 on the first shaft 20 that passes through the spring element 4 and the second slot 31, a so as to have the first shaft 20 and the spring element 4 stay inside the second slot 31 to allow the first shaft 20 to move telescopically along the second slot 31. The second shaft 30 is designed to assemble with the first slot 12 on the first arm 1 and a spring element 4 is mounted between the second shaft 30 and the first slot 12. A securing portion 32 is mounted on the second shaft 30, with a locking element 5 locking to the securing portion 32 on the second shaft 30 that passes through the spring element 4 and the first slot 12, so as to have the second shaft 30 and the spring element 4 stay inside the first slot 12 to allow the second shaft 30 to move telescopically along the first slot 12. When the locking element 5 is locked to the second shaft 30, a cover plate 14 is installed at one side of the first slots 12 on the first arm 1 for covering the locking element 5 locked to the second shaft 30.

In this embodiment, the base 10 of the present invention further comprises an assembling portion 13 for assembling with the webcam 6. The aforementioned spring element 4 is a spring coil, and the locking element 5 is a screw, with the securing portion 21, 32 being a screw hole. The securing portions 21, 31 is a screw if the locking element 5 of the present invention is a screw nut.

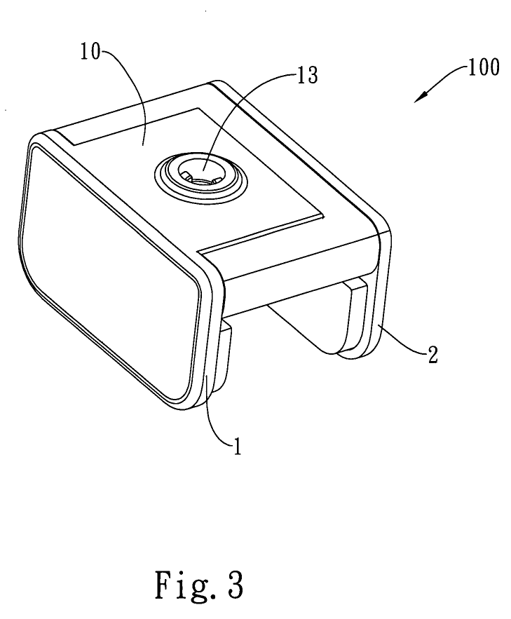

FIG. 3 shows a perspective view of the assembled clamping device for a webcam according to the present invention. When assembling a clamping device 100 for a webcam according to the present invention, first having the second shaft 30 pass through the spring element 4 and through the first slot 12 with connecting purposes before locking the securing portion 32 of the second shaft 30 to the locking element 5, so as to assemble the second shaft 30 with the first arm 1 and to have the spring element 4 stay inside the first slot 12. Then having the first shaft 20 pass through the spring element 4 and through the second slot 31 with connecting purposes before locking the securing portion 21 of the first shaft 20 to the locking element 5, so as to assemble the first shaft 20 with the second arm 2 and to have the spring element 4 stay inside the second slot 31. Finally, having the cover plate 14 cover one side of the first slots 12 on the first arm 1, so as to complete the assembling of the clamping device 100 for a webcam according to the present invention.

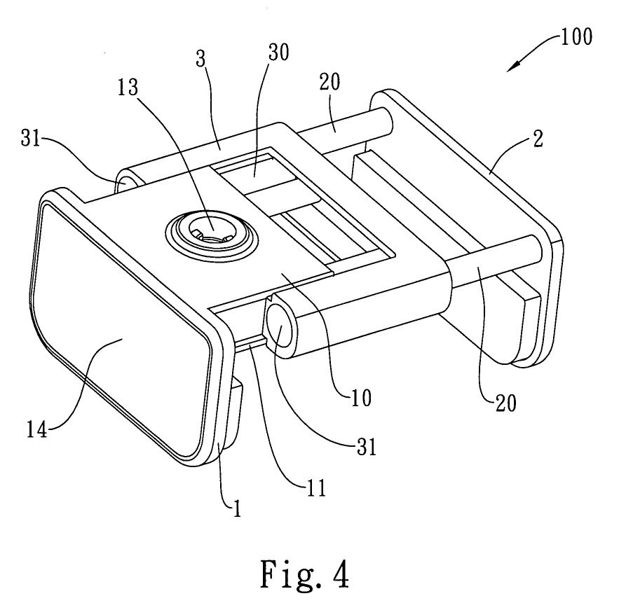

FIG. 4 shows an action perspective view of a clamping device for a webcam according to the present invention. When mounting the clamping device 100 for a webcam on a monitor display 7 (please refer to FIG. 5 and FIG. 6), the distance between the first arm and the second arm can be adjusted by pulling the first arm 1 or the second arm 2 to move the first shafts 20 and the second shafts 30 to compress the spring elements inside the second slots 31 and the first slots 12 to generate an elasticity, so as to allow the first shafts 20 and the second shafts 30 to move telescopically.

FIG. 5 shows an action perspective view of the clamping device for a webcam applied to a monitor display. When mounting the clamping device 100 for a webcam on a monitor display 7 with a thickness of d₁, the clamping device for a webcam 100 can be mounted on the monitor display by pulling the second arm 2 to move the first shafts 20 and to compress the spring elements 4 inside the second slots 31, so as to generate an elasticity to adjust the length of the first shafts 20 to the desired distance of d₁. By doing so, the clamping device 100 for a webcam according to the present invention can be properly adjusted to fit the thickness of the monitor display 7.

FIG. 6 shows an action view of another embodiment of the clamping device for a webcam applied to a monitor display. In this embodiment, the thickness d₂ of this monitor display 7 is larger than the thickness d₁ of the monitor display 7 shown in FIG. 5. Therefore, when mounting the clamping device 100 for a webcam on the monitor display 7 with the thickness of d₂, first extending the first shaft to a distance to generate a first extension by pulling the second arm 2 to move the first shaft 20 and to compress the spring element 4 inside the second slot 3. Then, by pulling the second arm 2 or the first arm 1 again, making the connecting member 3 move along the guide rails 11 through the sliding tracks 33 to move the second shaft 30 to compress the spring element 4 inside the first slot, the second shaft 30 is extended to such a point that the distance between the first arm and the second arm amounts to d2 to generate a second extension to have the clamping device 100 mounted on the monitor display 7. By doing so, the clamping device 100 for a webcam according to the present invention can make proper two-degree adjustment according to the thickness of the monitor display 7.

The clamping device for a webcam according to the present invention can be properly adjusted or can make two-stage adjustment according to the thickness of the monitor display, thereby is able to make extensive adjustment without being limited to apply only to monitor displays with certain thickness.

1. A clamping device for a webcam, comprising:
a first arm having an extending base bearing the webcam, with a first slot mounted at each lateral side of the base for connecting purposes;
a second arm having a pair of first shafts; and
a connecting member having a pair of second shafts corresponding to the first slots with connecting purposes and a pair of second slots with connecting purposes corresponding to the first shafts of the second arm, wherein the second shaft assembles with the first arm by locking to a locking element through a spring element and the first slot with connecting purposes, and the first shaft assembles with the second arm by locking to the locking element through the spring element and the second slot with connecting purposes, so that the distance between the first arm and the second arm can be adjusted by pulling the first arm or the second arm to compress the spring element inside the first slots or the second slots, so as to allow the first shaft and the second shaft to move telescopically.

2. The clamping device for a webcam as claimed in claim 1, further comprising an assembling portion for assembling with the webcam.

3. The clamping device for a webcam as claimed in claim 1, wherein a guide rail is mounted at the opposite side of each of the first slots mounted on both sides of the base for connecting purposes, with a pair of sliding tracks corresponding to the guide rails and mounted on the connecting member, so that the connecting member can move along the first arm telescopically by sliding along the guide rails through the sliding tracks when pulling or pushing the first arm or the second arm.

4. The clamping device for a webcam as claimed in claim 1, wherein the spring element is a spring coil.

5. The clamping device for a webcam as claimed in claim 1, wherein each of the first shafts and the second shafts has a securing portion for locking to the locking element.

6. The clamping device for a webcam as claimed in claim 5, wherein the locking element is a screw, and the securing portion is a screw hole.

7. The clamping device for a webcam as claimed in claim 5, wherein the locking element is a screw nut, and the securing portion is a screw.

8. The clamping device for a webcam as claimed in claim 5, wherein a cover plate is provided at one side of the first slots of the first arm for covering the locking element locked to the second shaft.

9. The clamping device for a webcam as claimed in claim 1, wherein the first shaft is extended to a distance to generate a first extension by pulling the second arm to move the first shaft to compress the spring element inside the second slot.

10. The clamping device for a webcam as claimed in claim 9, wherein the second shaft is extended to a distance to generate a second extension by pulling the second arm or the first arm again, so as to make the connecting member slide along the guide rails through the sliding tracks to move the second shaft to compress the spring element inside the first slot.
